(19) United States
(12) Patent Application Publication
(10) Pub. No.: US 2018/0290194 A1
(43) Pub. Date: Oct. 11, 2018

(54) ADDITIVE MANUFACTURING APPARATUS USING A SEMI-SOLID EXTRUSION OF WIRE

(71) Applicants: Amin Jabbari, Tehran (IR); Karen Abrinia, Tehran (IR)

(72) Inventors: Amin Jabbari, Tehran (IR); Karen Abrinia, Tehran (IR)

(21) Appl. No.: 15/898,836

(22) Filed: Feb. 19, 2018

(30) Foreign Application Priority Data
Apr. 8, 2017 (IR) 13965014000300049

(51) Int. Cl. B21C 23/00; B21C 37/04; B21C 29/00; B21C 23/08

(52) U.S. Cl. CPC B21C 23/005; B21C 37/045; B33Y 10/00; B21C 29/003; B21C 23/08; B21C 37/047

(57) ABSTRACT

An additive manufacturing apparatus to build a three-dimensional metal object using a semi-solid filament extrusion method is disclosed. A frame comprises a carriage capable of moving in Y-axis and Z-axis direction. The frame further comprises an extruder head, which is attached to a support section of the carriage is configured to move in X-axis direction to continuously print a filament in a layer by layer fashion using a thixo-extrusion process on a print bed in a pre-defined three-dimensional path. The filament is a treated metal alloy fed into the extruder head via a feeder mechanism and heated to a semi-solid state to allow the controlled flow of the slurry via a nozzle section to build the three-dimensional extruded object with the predetermined microstructure. The metal alloy is pre-processed using a heat treatment and a mechanical deformation technique to enhance the properties of the filament used in the semi-solid extrusion process.

### BACKGROUND OF THE INVENTION

Three-dimensional printing technology has paved the way to produce new and complicated parts in an easy and less expensive method. It is also known as additive manufacturing or AM which is a technique aimed at reducing the part costs by decreasing the material wastage and time to market the fabricated part. The process includes layer based manufacturing where the material is added in a layer-by-layer fashion to build the product according to the requirements. Additive manufacturing technique could provide better flexibility in geometry and great potential savings in time and cost.

Complex industrial parts could be manufactured directly from CAD data using metallic additive manufacturing. Up to date, there are three primary feedstock process forms for metal AM: (a) powder-bed methods, (b) powder-fed methods, (c) wire-fed methods; the first two uses laser or electron beam energy source for sintering/melting of the metal powder and the last one uses the same sources to melt a wire. Powder based method have been used to fabricate metallic parts, but they have numerous limitations such as high costs, low deposition rates, high energy consumption, residual stresses, larger thermal gradients, poor surface finish and high contamination. With the present metal 3D printing technologies economically and technically feasible manufacturing of metal components are hard to attain.

Wire feedstock method offers advantages for the supply of material for the additive manufacturing of metals. These wire feedstock methods offer better repeatability and higher deposition rates when compared to powder process. The metal wires are lower in cost and more available than metal powders which makes the wire feedstock methods more cost-effective and competitive. Using high-energy sources such as electric-arc, plasma, laser or electron beam in existing metal wire-fed additive manufacturing methods causes excess post-processing operations to enhance the microstructure and mechanical properties of the fabricated product, just like powder-based methods.

Despite massive progress being made in metal additive manufacturing techniques, the need for printing a metallic part with a similar integrity as in other conventional manufacturing process being comparable in production costs and mechanical properties. In most of the 3D printed metal components, contraction and thermal stresses are very problematic which have been reduced here to greater extent. In the current metal AM methods, the sintering or melting of the metal powders are required which cause thermal stresses resulting in the distortion of the product.

The key problems with existing metal additive manufacturing techniques are high costs for raw materials and equipment, limited speed for layering and part dimensions, high energy consumption, undesirable microstructure and residual stresses, contamination and hazardous dangers of metal powders. Further, all the processes require post processes such as elimination of glue, heat treatments, isostatic pressing and diffusion which increases time and cost for the manufacturing. Another key disadvantage is the existence of porosity or undesirable microstructural defects in the final product due to high temperature gradients.

Thus, in light of aforementioned drawbacks, there is a clear and present need for an additive manufacturing apparatus to economically fabricate 3D printed metal alloy components with enhanced mechanical properties.

### SUMMARY OF THE INVENTION

The present invention relates to an additive manufacturing apparatus to fabricate fully dense 3D printed metal alloy components using a semi-solid extrusion process. The fabricated metal parts are configured to have desired microstructural properties with enhanced mechanical properties.

In one embodiment, an additive manufacturing apparatus to build a three-dimensional object comprises a frame configured to have a carriage capable of moving in a Y-axis and a Z-axis direction, wherein an extruder head attached to a support section of the carriage is configured to move in an X-axis direction to continuously print a filament in a layer by layer fashion using a thixo-extrusion process on a print bed in a pre-defined three-dimensional path. Thixo-extrusion is referred to extrusion of a partially melted feedstock below the liquidus temperature of the alloy. The filament is a metal alloy fed into the extruder head via a feeder mechanism disposed in the support section and heated to a semi-solid state to allow the controlled flow of the semi melted filament via a nozzle section to build the three-dimensional extruded object with the predetermined microstructure. This causes lower energy consumptions against existing metal AM methods.

In one embodiment, the filaments printed in the layer by layer fashion are well bound together using the particular rheological properties of the semi-solid metal (SSM) alloy to fabricate the three-dimensional object. Further, the metal alloy is pre-processed using a heat treatment and a mechanical deformation technique to enhance the properties of the filament and viscosity control. Semi solid metals with broken dendrites have pseudoplastic thixotropic flow behavior. A specific thermo-mechanical cycle prepares a 3D printable metallic filament with desired flow behavior. This is due to prevent clogging of the nozzle during deposition process.

In one embodiment, the carriage in the additive manufacturing apparatus comprises a first column and a second column configured to move in Z-axis direction using a step motor to fabricate the three-dimensional object with a predetermined thickness. The carriage provides the system of motion for the 3D printing apparatus using a three-axes Cartesian coordinate system wherein the Y-axis motion is accomplished by the frame and the X-axis motion is carried out by the extruder head attached to the support section of the carriage.

In another embodiment, the additive manufacturing apparatus to build a three-dimensional object comprises a frame configured to have a carriage capable of moving in a Y-axis and a Z-axis direction, wherein an extruder head attached to a support section of the carriage is configured to move in an X-axis direction to continuously print a filament in a layer by layer fashion using a thixo-extrusion process on a print bed in a pre-defined three-dimensional path. The filament is a metal wire fed into the extruder head via a feeder mechanism disposed in the support section and heated to a semi-solid state to allow the controlled flow of the filament via a nozzle section to build the three-dimensional extruded object with the predetermined microstructure. The feeder mechanism in the support section comprises an electric motor and a pinch roller to drive the filament to the extruder head. The extruder head comprises at least one of a heater, a heat sink, a barrier, a tube and a channel to build the three-dimensional extruded object via the nozzle using the thixo-extrusion process. The wire thermodynamic cycle, feed rate, solid fraction, nozzle and chamber geometry are considered in the thixo-extrusion process for desired results. In one embodiment, thixo-extrusion feedstock is integrated into the portable semi-solid continuous extrusion head.

One aspect of the present disclosure is directed to the additive manufacturing apparatus configured to employ the semi-solid extrusion of metallic wire for fabrication of 3D printed metal parts. In the present invention, the metal wire is brought to a semi-solid state and then it is extruded using the thixo-extrusion head to print the metallic component in a continuous layer by layer fashion by controlling the rheological properties of the semi-solid alloy. This apparatus provides means for the high speed and low-cost AM of metallic parts with large as well as smaller dimensions.

One aspect of the present disclosure is directed to a metal additive manufacturing apparatus to build a three-dimensional object comprising (a) a frame comprises a carriage capable of moving in a Y-axis and a Z-axis direction; (b) a compact extruder head attached to a support section of the carriage, wherein the compact extruder head is configured to move in an X-axis direction to continuously print a filament in a layer by layer manner using a semi-solid extrusion process on a bed in a three-dimensional path; (c) wherein the filament is a metal alloy fed into the extruder head via a feeder mechanism disposed in the support section and heated to a semi-solid state to allow the controlled flow of the filament via a nozzle section to build the three-dimensional extruded object with the predetermined microstructure.

Another aspect of the present disclosure is directed to an additive manufacturing apparatus to build a three-dimensional object comprising: (a) a frame comprises a carriage capable of moving in a Y-axis and a Z-axis direction; (b) a compact extruder head attached to a support section of the carriage, wherein the compact extruder head is configured to move in an X-axis direction to continuously print a filament in a layer by layer fashion using a continuous thixo-extrusion process on a print bed in a pre-defined three-dimensional path; (c) wherein the thermomechanical filament is a metal wire fed into the extruder head via a feeder mechanism disposed in the support section and heated to a semi-solid state to allow the controlled flow of the filament via a nozzle section to build the three-dimensional extruded object with the predetermined microstructure; and (d) wherein the extruder head comprises at least one of a heater, a heat sink, a barrier, a tube and a channel to build the three-dimensional extruded object via the nozzle section using the thixo-extrusion process. In one embodiment, the apparatus further comprises a temperature control system having one or more sensors and thermometers to regulate the temperature of the thixo-extrusion process.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

3D printable metallic filament requires a pre-process to obtain desirable microstructure for semi-solid extrusion. So, to use a metallic filament as a wire feedstock, some material preparation is needed to obtain the desired rheological properties for the semi-solid extrusion process. Then the pretreated wire is fed into the thixo-extruder and reheated to semi-solid temperature and extruded on the bed. This also needs design and development of a continuous wire thixo-extruder.

### BRIEF DESCRIPTION OF DRAWINGS

FIG. 1 illustrates a perspective view of an additive manufacturing apparatus to build a three-dimensional object, according to one embodiment.

FIG. 2 illustrates a semi-solid metal extrusion mechanism using an extruder head for layer by layer deposition of the SSM on a print bed, according to one embodiment.

FIG. 3 illustrates a wire thermo-mechanical treatment process using an extruder head used in the apparatus, according to one embodiment.

FIG. 4A shows the schematic of the dendritic microstructure evolution of the filament used for 3D printing, according to another embodiment.

FIG. 4B shows the schematic of the directional change in the material post extrusion process, according to another embodiment.

FIG. 4C shows the schematic of the globular structure of the filament in semi-solid state, according to another embodiment.

FIG. 5A illustrates the perspective view of the thixo-extruder head used in the apparatus, according to one embodiment

FIG. 5B illustrates a sectional view of a thixo-extruder head used in the apparatus, according to one embodiment.

FIG. 6 illustrates a perspective view of the thixo-extruder head attached to a support section of a carriage, according to one embodiment.

FIG. 7A shows a front view of the additive manufacturing apparatus, according to another embodiment.

FIG. 7B shows a side view of the additive manufacturing apparatus, according to another embodiment.

FIG. 7C shows a top view of the additive manufacturing apparatus, according to another embodiment.

### DETAILED DESCRIPTION

A description of embodiments of the present invention will now be given with reference to the figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The present invention generally relates to an additive manufacturing apparatus to fabricate 3D printed metal components using a semi-solid extrusion process of wire. The fabricated metal parts are configured to have desired microstructural properties with enhanced mechanical properties.

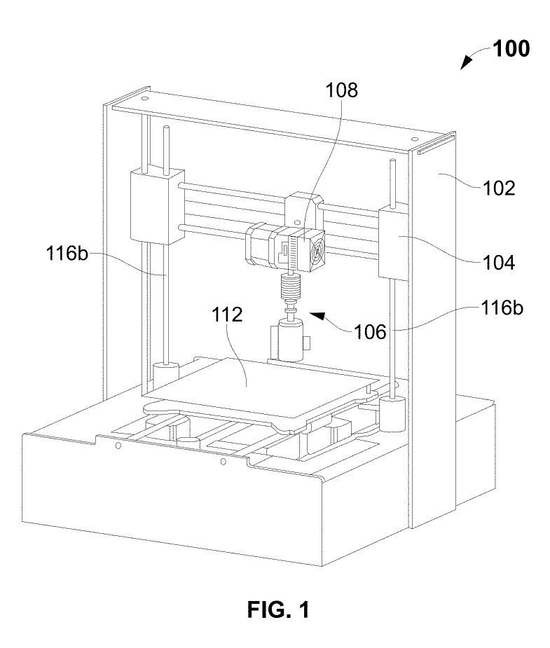

In one embodiment as shown in FIG. 1, an additive manufacturing apparatus 100 to build a three-dimensional object comprises a frame 102 configured to have a carriage 104 capable of moving in a Y-axis and a Z-axis direction, wherein an extruder head 106 attached to a support section of the carriage 104 is configured to move in an X-axis direction to continuously print a filament 110 in a layer by layer fashion using a thixo-extrusion process on a print heated bed 112 in a pre-defined path. The filament 110 is a metal alloy fed into the extruder head 106 via a feeder mechanism 108 disposed in the support section and heated to a semi-solid state to allow the controlled flow of the filament 110 via a nozzle section 114 to build the three-dimensional extruded object with the predetermined microstructure.

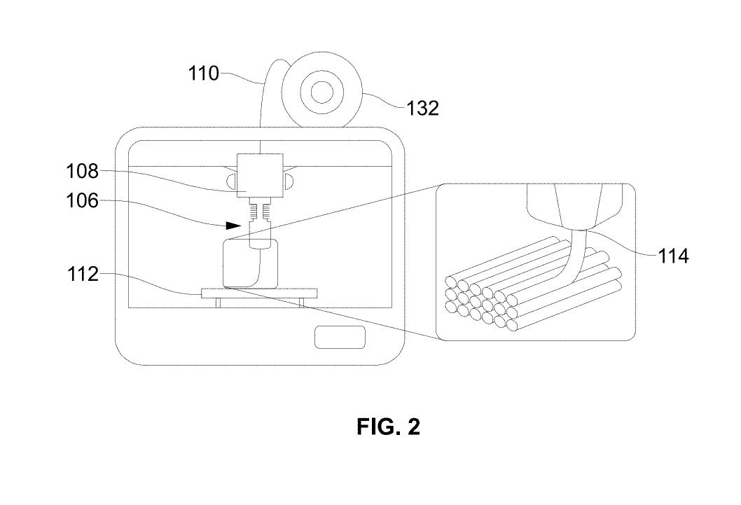

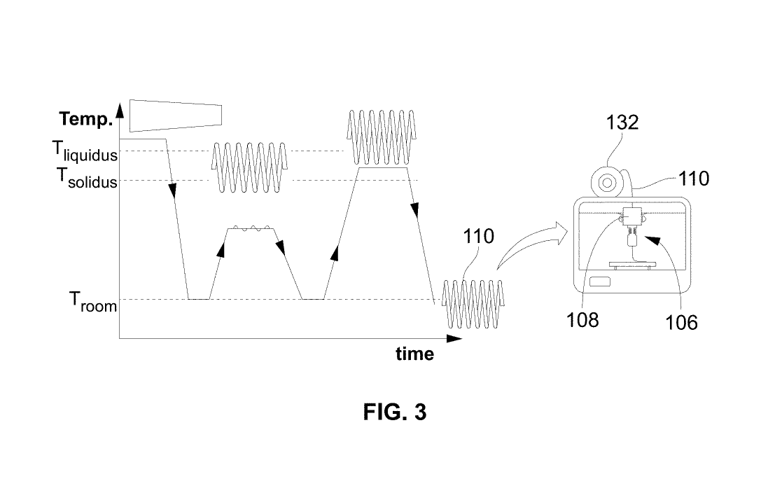

One aspect of the present disclosure is directed to the additive manufacturing apparatus 100 configured to employ the semi-solid extrusion of metallic wire for fabrication of 3D printed metal alloys. The semi-solid extrusion is incorporated with 3D printing technique to have controlled process for fabricating the metal component with the desired microstructure and the subsequent mechanical properties. Further, the bound between the layers in the print bed are effectively controlled as shown in FIG. 2. The exiting material or the deposition of the bead from the thixo-extruder head 106 on the print bed 112 is clearly shown. In the present invention, the metal wire is brought to a semi-solid state and then it is extruded using the thixo-extrusion head 106 to print the metallic component in a continuous layer after layer method by controlling the rheological properties of the semi-solid material as shown in FIG. 3. This apparatus 100 provides means for the high speed and low-cost productions of metallic parts with large as well as smaller dimensions.

In preferred embodiments as shown in FIG. 3, the extrusion of the semi-solid metal alloy is an essential aspect in the development for 3D printing technique. This helps to mitigate all the thermal stresses which would be caused as a result of using prior art techniques such as sintering or melting of the metal powders. In the present invention, the temperature of the metal alloy used in the process does not even reach a complete melting temperature and because of which all the associated thermal stresses could be mitigated. The thixo-extrusion process is configured to control the solid fraction and the rate of layering of the semi-solid metal alloy on the print bed 112. Therefore, the shear behavior of the metal alloy could be easily controlled and the required microstructure for the 3D printed metal component could be obtained.

According to an embodiment of the invention as shown in FIG. 3, the filaments using the viscosity and the rheological properties of the semi-solid metal alloy to fabricate the three-dimensional object. The filaments 110 are metal alloys in the form of wires so that it could be conveniently fed from a filament spool 132 to the extruder head which is a thixo-extruder head 106 in the present invention. This metal alloy is pre-processed using a heat treatment and a mechanical deformation technique to enhance the properties of the filament 110. The metallurgical preparation of the metal wire for the process of production of the filament 110 is accomplished in the present invention. To get the desired microstructural properties of the 3D printed metal component, these metal alloys are pre-processed using the thermos-mechanical treatment.

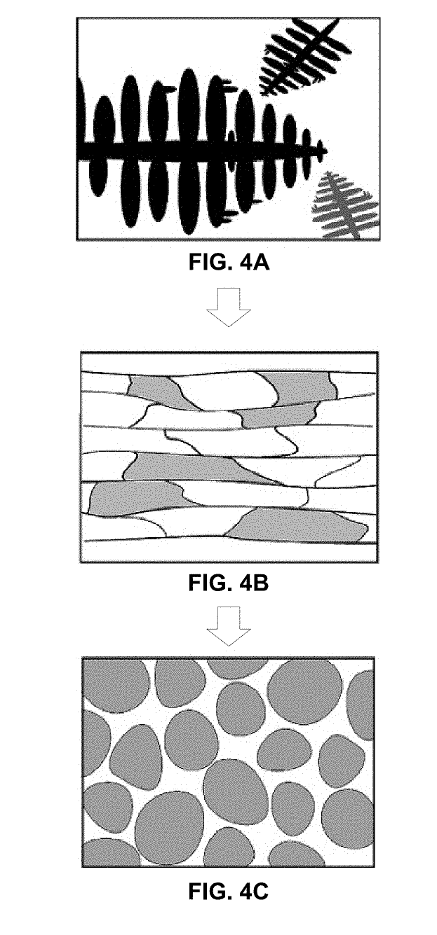

In another embodiment, FIG. 4A-4C illustrates the breaking of cast dendritic microstructure to a globular microstructure to improve the rheological properties and printability of the filament using the apparatus 100. As shown in shown in FIG. 4A which shows the microstructure evolution of the semi solid metal alloy. The microstructure for the raw material which is a metal alloy should have special characteristics such as having almost spherical (non-dendritic) and small size grains with an even distribution. This would mean that in a semi solid state of the metal alloy, these small grains would be evenly distributed in the liquid phase as shown in FIG. 4B.

Producing a non-dendritic structure for the metal alloy could be achieved by the controlled solidification of the liquid alloy in certain conditions or in the solid state by sever plastic deformation and recrystallizations. In the present process, this is achieved by cold working and then going through a special heat treatment to attain the metal filament 110 needed for the 3D printing technique shown in FIG. 4C. This raw material or filament 110 is printed through the thixo-extruder head 106 of the apparatus 100 in the semi-solid state.

In another embodiment as shown in FIG. 1, the additive manufacturing apparatus 100 to build the three-dimensional object is disclosed. The apparatus 100 comprises a frame 102 which is a table having the carriage 104 mounted on it. The carriage 104 is configured to move in a 3-axes Cartesian coordinate system wherein the Y-axis motion is accomplished by the frame 102 and the X-axis motion is carried out by the extruder head 106 attached to the support section of the carriage 104. The carriage 104 further comprises a first column 116a and a second column 116b configured to move in Z-axis direction using a step motor to fabricate the three-dimensional object with a predetermined thickness. The apparatus 100 is configured to move in 180 mm by 180 mm by 130 mm in X. Y and Z-axis respectively to fabricate the final component.

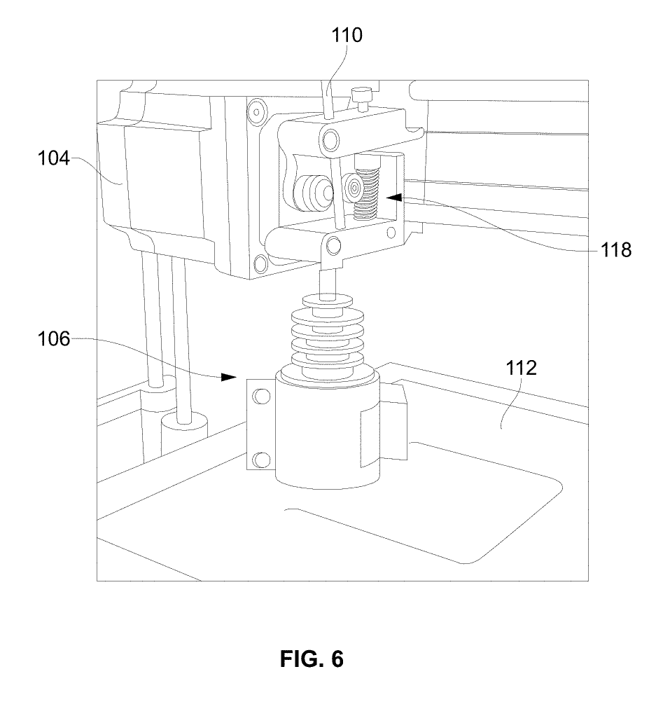

As shown in shown in FIG. 2, the printer head is the extruder head 106 comprises a mechanism for feeding the filament. The feeder mechanism 108 comprises a pinch roller 118 as shown in FIG. 6 driven by a motor to drive the filament 110 to the extruder head 106. In exemplary embodiment, a motor with high torque such as Nema 23 stepper motor could be used to drive the pinch roller 118. The metal wire or filament 110 is fed from a filament spool 132 and heated up to its semi-solid state. The solid portion of the filament 110 acts as a piston to push the semi-molten alloy through the nozzle section 114. The extruder head 106 uses a thixo-extrusion process to extruded semi-solid metal alloy for layering it in the print bed 112 to fabricate the product.

In another embodiment, the motion control for the additive manufacturing apparatus 100 uses a modular electronic set such as RAMPS interface wherein the drivers for the step motors are designed in separate boards and assembled on the main board. The main board itself acts as a shield for the multi-purpose board. All adjustments commands are conveyed by a computer to the apparatus 100 using a software like Pronterface which is utilized by the user. The commands are automatically conveyed by the software and the user could easily determine the conditions for printing the component using a three-dimensional model with a STL format. Using this apparatus, the three-dimensional path is defined by a slicing software file for fabricating the three-dimensional object.

In a different embodiment shown in FIG. 6, an additive manufacturing apparatus 100 to build a three-dimensional object is disclosed. A frame 102 comprising a carriage 104 capable of moving in a Y-axis and a Z-axis direction, wherein an extruder head 106 attached to a support section of the carriage 104 is configured to move in an X-axis direction to continuously print a filament 110 in a layered manufacturing using a thixo-extrusion process on a print bed 112 in a G-code defined path.

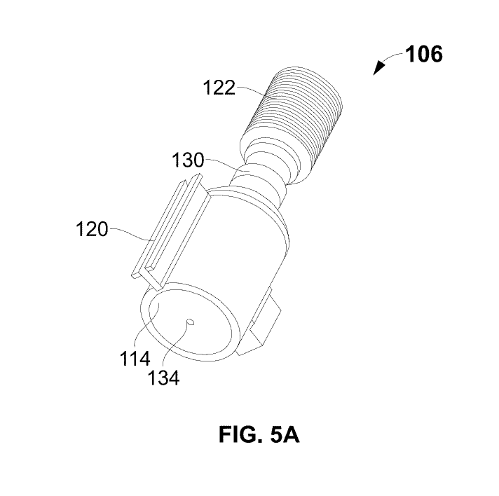

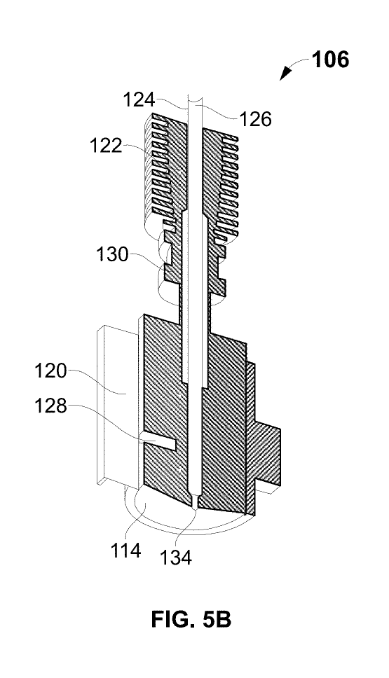

The filament 110 is a metal wire fed into the extruder head 106 as shown in FIG. 5A via a feeder mechanism 108 and heated to a semi-solid state to allow the controlled flow of the filament 110 via the nozzle section 114 to build the three-dimensional object with the predetermined microstructure. As shown in FIG. 5B, the extruder head 106 comprises at least one of a heater 120, a heat sink 122, a tube 124, a channel 126 and a barrier 130 to build the extruded object via the nozzle section 114 using the thixo-extrusion process. The heat barrier 130 is configured to act as a physical limit to prevent heat conduction towards the upper part of the thixo-extruder head 116 in the apparatus 100. The annular heat sinks 122 is configured and built above the heat barrier 130 to minimize the heat conduction towards the cold end and feeder mechanism 108. The nozzle section 114 comprises an orifice 134 configured to allow the controlled flow of the filament 110 through the extruder head 106.

In one embodiment as shown in FIG. 6, the extruder head 106 which does the thixo-extrusion process is configured to have one or more components to effectively extrude the semi-solid metal alloy for printing the desired component with desired mechanical properties. The extruder head 106 includes a temperature control system 128 having one or more sensors and thermistors to regulate the temperature of the thixo-extrusion process.

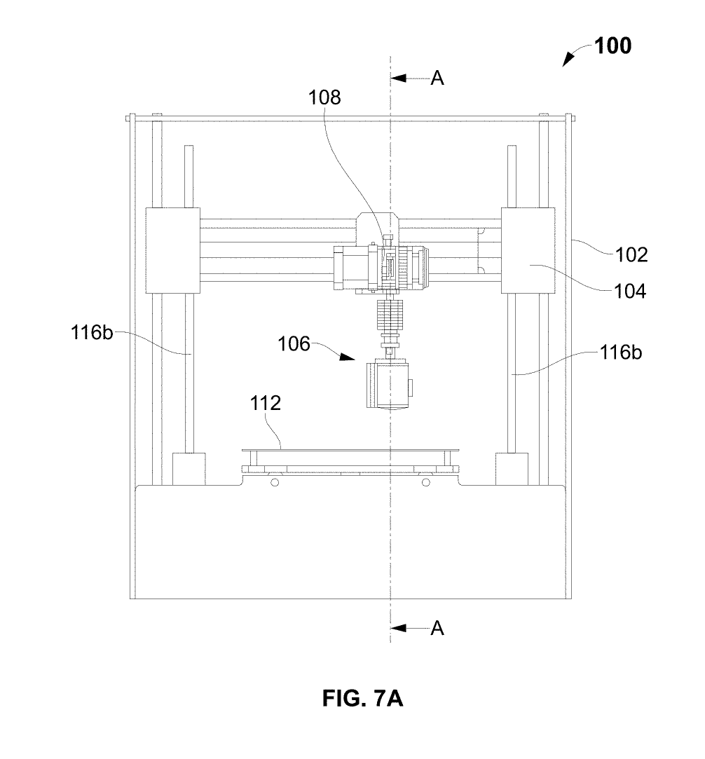

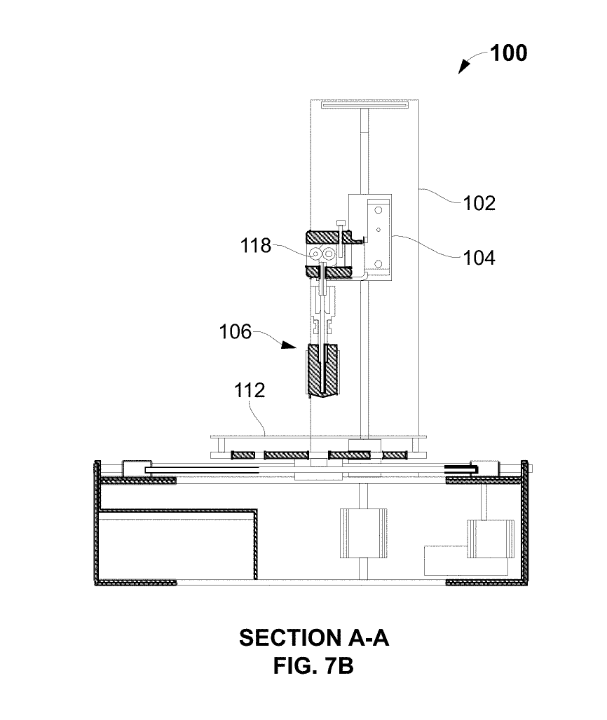

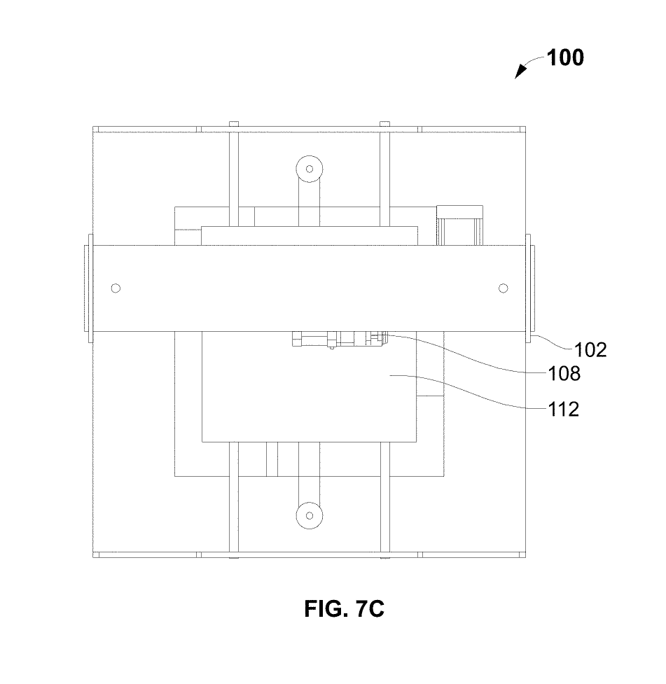

In other embodiments of the present invention shown in FIG. 7A, the 3D printing process using the additive manufacturing apparatus 100 is disclosed. In this process, a narrow thin layer of the metal alloy is extruded through the nozzle section 114 and flows on top of the print bed 112 or previous printed layers in a pre-defined three-dimensional path. During the process, the bounding of layers to each other is made possible by the high viscosity and rheological properties of the semi solid metal alloy. Since the speed of the material flow in the process could be increased compared to prior art techniques, a higher production rate for the metal components using the apparatus 100 as shown in FIG. 7B could be achieved.

In exemplary embodiment shown in FIG. 7C, the process of semi solid extrusion of metal alloys is done through a small die at low temperatures that was incorporated to a simple FDM 3D printing apparatus and design parameters were modified to reach a stable process. A CAD software produces a file with an extension like .Obj or .STL. This file is in the form of a network of lines which surrounds a 3D volume. Then, the 3D printer software slices the object into hundreds of layers with small thicknesses. Based on this geometry, the real shape of the component is printed layer by layer using the apparatus 100 according to the slices made in the software.

In preferred embodiments, using the additive manufacturing apparatus 100, a lesser contraction of the final manufactured metal component is obtained because of the semi-solid state and lower temperatures. The problems associated with the contraction and thermal stresses from the process are completely mitigated. The method of using the apparatus 100 to print the extruded semi-solid metal alloy as shown in FIG. 7A comprises: a) preprocessing the filament 110 such as the metal wire by the heat treatment and the mechanical deformation technique to obtain the required properties and b) then it is fed to the extruder head 106 using the pinch roller 118 in the feeder mechanism 108 as shown in FIG. 6 where it is heated up to semi-solid state and c) then it is extruded through the thixo-extruder head 106 via the nozzle section 114 in the layered fashion and d) fabricating the final printed component by bounding layers together to form a small thickness in the Z-axis direction of the component using the high viscosity and rheological properties of the semi solid alloy to produce the cross-sections of the geometry at each stage of the process.

In preferred embodiments as shown in FIG. 7C, the designing and configuration of the additive manufacturing apparatus 100 using the semi-solid extrusion eliminates all the limitations of the prior art techniques to fabricate 3D printed metal components. This apparatus 100 provides higher rate of layering of the filaments 110 for fabrication compared to existing techniques. Another key advantage is that the final part geometrical distortions due to contraction and thermal stresses are minimal since the semi solid state of the metal is not wholly liquid and there is lower working temperature as compared to other metal AM processes. The preconditioned metallic filaments 110 could be deposited on a substrate in a semi-solid state for the controlled microstructure of the fabricated metal parts.

The final metal product fabricated by this additive manufacturing apparatus 100 is porosity free and due to the higher rate of printing and the present method is favored for the manufacture of large geometries. Furthermore, because it is possible for the present method to have thicker layers of materials because semi solid alloys could bare their own weight much better that molten metals, larger components could be produced easier as compared with previous methods. The semi solid metal flow is determined by the apparent viscosity of the alloy and the time scale that the viscous flow take place is determined by the time needed for the previous layer's solidification. This means that one could easily control the rate of layering which is unique to this process.

It is also possible to modify the microstructure of the final product by controlling the solid fraction and its shear history so that different mechanical properties could be obtained. The parts manufactured by the present method do not need any more processing such as the elimination of glue or bounding agent, further heat treatment, isostatic pressing or diffusion bounding thereby making this apparatus 100 and the process time saving and cost-efficient.

One aspect of the present disclosure is directed to the apparatus 100 for 3D printing to fabricate metal components with the advantage of utilizing the rheological and thermos physical of the semi solid alloys to produce a near net shape components without any need for further processes such as sintering, molding, machining or other secondary processes. The produced metal component has better microstructural characteristics and lower expense and larger sizes could be easily produced in shorter time without any post-processing techniques. The ease of controlling the microstructure of the final printed part by determining the solid fraction while extruding the semi-solid metal alloy. Further, the printed metallic parts using the apparatus 100 could have only minimum voids or porosity and less costs for shorter lead time.

One aspect of the present disclosure is directed to an additive manufacturing apparatus 100 to build a three-dimensional object comprising: (a) a frame 102 comprises a carriage 104 capable of moving in a Y-axis and a Z-axis direction; (b) an extruder head 106 attached to a support section of the carriage 104, wherein the extruder head 106 is configured to move in an X-axis direction to continuously print a filament 110 in a layer by layer fashion using a thixo-extrusion process on a print bed 112 in a pre-defined three-dimensional path; (c) wherein the filament 110 is a metal alloy fed into the extruder head 106 via a feeder mechanism 108 disposed in the support section and heated to a semi-solid state to allow the controlled flow of the filament 110 via a nozzle section 114 to build the three-dimensional extruded object with the predetermined microstructure.

The filaments 110 printed in the layer-wise fashion may be bound together using the viscosity and the rheological properties of the semi-solid metal alloy to fabricate the three-dimensional object. The metal alloy may be pre-processed using a heat treatment and a mechanical deformation technique to enhance the properties of the filament 110. The carriage 104 may comprise a first column 116a and a second column 116b configured to move in Z-axis direction using a step motor to fabricate the three-dimensional object with a predetermined thickness. The feeder mechanism 108 may comprise the pinch roller 118 driven by a motor to drive the filament 110 to the extruder head 106. The nozzle section 114 moving path may be defined by a CAD software file for fabricating the three-dimensional metal part. The thixo-extrusion process may be configured to control the solid fraction and the rate of layering of the semi-solid metal alloy on the print bed.

Another aspect of the present disclosure is directed to an additive manufacturing apparatus 100 to build a three-dimensional object. The apparatus 100 may comprise a frame 102 comprises a carriage 104 capable of moving in a Y-axis and a Z-axis direction; and an extruder head 106 attached to a support section of the carriage 104, wherein the extruder head 106 is configured to move in an X-axis direction to continuously print a filament 110 in a layer by layer fashion using a thixo-extrusion process on a print bed 112 in a three-dimensional path.

The apparatus 100 may further be configured such that the filament 110 is a metal wire fed into the extruder head 106 via a feeder mechanism 108 disposed in the support section and heated to a semi-solid state to allow the controlled flow of the filament 110 via a nozzle section 114 to build the part with the predetermined microstructure; and furthermore wherein the extruder head 106 comprises at least one of a heater 120, a heat sink 122, a barrier 130, a tube 124 and a channel 126 to build the extruded object via the nozzle orifice 114 using the thixo-extrusion process. The apparatus 100 may further comprise a temperature control system 128 having one or more sensors and thermistors to regulate the temperature of the thixo-extrusion process.

The commercial application of the present invention includes all possible applications of the metal additive manufacturing processes. Most of the complicated parts could be manufactured using this apparatus 100 and process. In exemplary embodiment, the apparatus 100 could be used to fabricate turbine blades or spray nozzles with inside curved channels for cooling with enhanced mechanical properties and controlled microstructures. Further, the apparatus 100 could also be used to manufacture complex parts from aluminum alloys without any post processing techniques.

Unique rheological properties of semi-solid alloys cause excellent extrudability and layering quality. In one example, The main present disclosure invention is about metal AM print head which works below liquidus temperature of alloy and thermo-mechanically treated filament without need to any other in situ operations in semi-solid extrusion print head. Partially melting of a metallic filament is a much more straightforward method as opposed to the partially solidifying of molten metals.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method.

Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein. While the above is a complete description of the preferred embodiments of the invention, various alternatives, modifications, and equivalents may be used. Therefore, the above description and the examples should not be taken as limiting the scope of the invention, which is defined by the appended claims.

1. A metal additive manufacturing apparatus to build a three-dimensional object comprising:
a frame comprises a carriage capable of moving in a Y-axis and a Z-axis direction,
an extruder head attached to a support section of the carriage, wherein the compact extruder head is configured to move in an X-axis direction to continuously print a metallic filament in a layer by layer fashion using a continuous thixo-extrusion process on a print bed in a pre-defined three-dimensional path;
wherein the filament is a thermomechanical treated metal alloy fed into the extruder head via a feeder mechanism disposed in the support section and heated to a semi-solid state to allow the controlled flow of the filament via a nozzle section to build the three-dimensional extruded object with the predetermined microstructure.

2. The apparatus of claim 1, wherein the filaments printed in the layer by layer fashion are bound together using the viscosity control and the rheological properties of the semi-solid metal alloy to fabricate the three-dimensional object.

3. The apparatus of claim 1, wherein the metal alloy is pre-processed using a heat treatment and a mechanical deformation technique to enhance the properties of the filament.

4. The apparatus of claim 1, wherein the carriage comprises a first column and a second column configured to move in Z-axis direction using a step motor to fabricate the object with a predetermined thickness in three-dimensions.

5. The apparatus of claim 1, wherein the feeder mechanism comprises a pinch roller driven by a motor to drive the filament to the extruder head.

6. The apparatus of claim 1, wherein the thixo-extrusion feedstock is integrated into the portable semi-solid continuous extrusion head.

7. The apparatus of claim 1, wherein the pre-defined three-dimensional path is defined by a CAD/CAM software file for additive fabrication the metal part.

8. The apparatus of claim 1, wherein the thixo-extrusion process is configured to control the solid fraction and the rate of layering of the semi-solid metal alloy on the print bed.

9. An additive manufacturing apparatus to build a three-dimensional object comprising:
a frame comprises a carriage capable of moving in a Y-axis and a Z-axis direction,
an extruder head attached to a support section of the carriage, wherein the extruder head is configured to move in an X-axis direction to continuously print a filament in a layer by layer fashion using a continuous thixo-extrusion process on a print bed in a pre-defined three-dimensional path;
wherein the filament is a metal wire fed into the extruder head via a feeder mechanism disposed in the support section and heated to a semi-solid state to allow the controlled flow of the filament via a nozzle section to build the three-dimensional extruded object with the predetermined microstructure and
wherein the compact extruder head comprises at least one of a heater, a heat sink, a barrier, a tube and a channel to build the extruded solid object via the nozzle section using the thixo-extrusion process.

10. The apparatus of claim 9, further comprises a temperature control system having one or more sensors and thermistors to regulate the temperature of the thixo-extrusion process.
